(19) United States
(12) Patent Application Publication
(10) Pub. No.: US 2003/0018397 A1
(43) Pub. Date: Jan. 23, 2003

(54) Control device for an electronic apparatus

(76) Inventor: Frederic Chanu, Saint Pavace (FR)

Correspondence Address: U.S. Philips Corporation, 580 White Plains Road, Tarrytown, NY, 10591, US

(21) Appl. No.: 10/180,619

(22) Filed: Jun. 26, 2002

(30) Foreign Application Priority Data
Jun. 26, 2001 (FR) 0108421

(51) Int. Cl. G05B 11/01; G05B 15/00

(52) U.S. Cl. 700/17; 700/19; 700/20; 700/83

(57) ABSTRACT

The invention proposes a control device for an electronic apparatus of the type which consists of a control member (60) which has at least two opposite top lateral selection zones (62, 64, 66, 68) to which a control force can be applied and each of which is associated with a bottom actuation portion which is able to cooperate with a triggering member (26) associated with an electrical switch (28), characterized in that the control member (60) is produced in two parts (80, 82), a first top part (80) of which carries at least said two lateral validation zones (62, 64, 66, 68) and a second bottom part (82) of which carries at least said two bottom actuation portions and has a central stud (84) which passes vertically through the first part (80).

The invention proposes a device for controlling an electronic apparatus.

The invention proposes more particularly a device for controlling an electronic apparatus of the type consisting of a control member which has at least two opposite lateral top selection zones.

In general terms electronic apparatus such as telephones of the mobile type or organizers consist of a casing in which there are arranged in particular a keypad, a display device and a device for controlling the movement of a cursor on the display device.

The display device supplies alphanumeric information which can be very varied, such as figures or letters but also pictograms, drawings or images.

It frequently happens that the display devices on mobile telephones have pictograms or characters which can be figures and/or letters, distributed on several display rows and columns and which can represent the wording of a function of the telephone.

Mobile telephones are to have ever more functions. In order to manage them, it is known that use can be made of menus of the pull-down type whose complexity increases with the number of functions. The simplicity and speed of the selection of the required function is then an important characteristic of the ergonomics of the apparatus.

It is then necessary to be able to move a cursor quickly and easily on a display device so as to be able to position it on each of the characters, or on or opposite the wording of a function.

Thus the control device can for example permit the activation of a selection function.

The selection function allows notably the navigation of a cursor on the display screen. The navigation can consist of causing the movement of the cursor on the screen. It can also consist of causing the scrolling on the screen of a list of menus containing the title of at least some of the functions which can be executed by the electronic apparatus.

The control device also allows the activation of a function validating the selected function.

In a known fashion, the control device can consist of two keys.

A first key has at least two arms which each correspond to a direction of movement of the cursor. It is mounted so as to tilt about a transverse axis which lies in a direction substantially perpendicular to the direction of alignment of the two arms.

Each arm has a top selection zone to which it is possible to apply a control force and a bottom actuation zone which can be produced in the form of a finger which extends vertically downwards and which is able to cooperate with a triggering member associated with an electrical switch.

Thus, when a selection force is applied to one of the top selection zones, the first key tilts about the transverse axis so that the bottom free end of the finger cooperates with the associated triggering member and activates a corresponding function, which can be the selection of a function whose title is displayed on the screen.

The second key has, in a similar fashion to the first, a top validation zone and a bottom actuation zone which can be produced in the form of a finger and extends vertically downwards and which is able to cooperate with a triggering member associated with an electrical switch. It is mounted so as to be able to move in translation in a vertical validation direction.

Thus, when a selection force is applied to the top validation zone, the second key is moved in translation downwards so that the bottom free end of the finger cooperates with the associated triggering member and activates a corresponding function, which can be the validation of the previously selected function.

However, such a control device is bulky. This is because it requires an electrical switch to be associated with each selection direction and with the validation of the selected function.

So as to reduce the bulkiness of the control device, it can consist of a single first key which is similar to that described above and which in addition is mounted so as to be able to move in translation in a vertical validation direction.

The selection of a function by the navigation of the cursor is identical to the selection described previously. The validation of the selected function consists of exerting a vertical control force on a top wall of the key so as to cause its vertical downward translation so that all the bottom actuation zones cooperate simultaneously with the members triggering the facing electrical switches. Thus the simultaneous actuation of the triggering members validates the selected function.

Such a control device has a reduced size. This is because it requires only the same number of switches as there are selection directions. The additional function of validating the selected function is performed by the simultaneous actuation of the switches associated with each selection direction. However, it is very difficult or even impossible to implement in a reliable fashion.

During validation, it frequently happens that the control force is offset or off-center with respect to the center of the control device. In this case, during the vertical translation, the control device tilts slightly, which produces a slight shift between the times of cooperation of each bottom portion with the associated triggering member. Thus, instead of validating the selected function, the application of the validation force will cause the unintentional selection of another function.

Such a lack of reliability in functioning is unacceptable.

In order to provide a solution to this problem, the invention proposes a device for controlling an electronic apparatus of the type which consists of a control member which has at least two opposite lateral top selection zones to which it is possible to apply a control force and each of which is associated with a bottom actuation portion which is able to cooperate with an associated triggering member of an electrical switch, of the type in which the control member is mounted so as to tilt about a selection axis which extends in a direction perpendicular to the direction of alignment of the two switches, between an intermediate idle position and two opposite selection positions, when a force is applied to one or other of the top selection zones, so that the corresponding bottom actuation portion cooperates with the associated triggering member and activates a first or second selection function, and of the type in which the control member is mounted so as to be able to move in translation in a vertical validation direction orthogonal to the direction of alignment and to the selection axis, between the idle position and a pressed-in position, when a validation force is applied to a third central validation zone of the control member, in which the two opposite bottom actuation portions cooperate simultaneously with the two associated triggering members so as to activate a validation function of the apparatus, characterized in that the control member is produced in two parts, a first top part of which carries at least said two lateral validation zones and a second bottom part of which carries at least said two bottom actuation portions and has a central stud which passes vertically through the first part and whose top free end face constitutes the third central validation zone.

According to other characteristics of the invention:

the first part has four lateral selection zones which are distributed angularly at 90° around the central validation zone and each of which is associated with a bottom portion, and the four bottom portions are carried by the second part, so that, when a validation force is applied to the central validation zone, the four bottom portions cooperate simultaneously with the associated triggering members in order to activate the validation function,

the first part has four lateral selection zones which are distributed angularly at 90° around the central validation zone and each of which is associated with a bottom portion, and the two opposite bottom portions are carried by the second part, the other two opposite bottom portions being carried by the bottom face of the first part, so that, when a validation force is applied to the central validation zone, the two bottom portions carried by the second part cooperate simultaneously with the associated triggering members in order to activate the validation function,

the control device has means for the elastic return of the two parts against top stops which define their idle positions,

the top stop of the second part is a bottom surface of the first part,

the elastic return means belong to the associated electrical switches,

the control device has means of guiding the second part in vertical translation so as to assist the simultaneous cooperation of the actuation portions which it carries with the associated triggering members, when the central zone is controlled.

The invention also proposes an electronic apparatus which has a control member as claimed in any one of the preceding claims, characterized in that it consists of a mobile telephone of the GSM type.

The invention will be further described with reference to examples of embodiments shown in the drawings to which, however, the invention is not restricted:

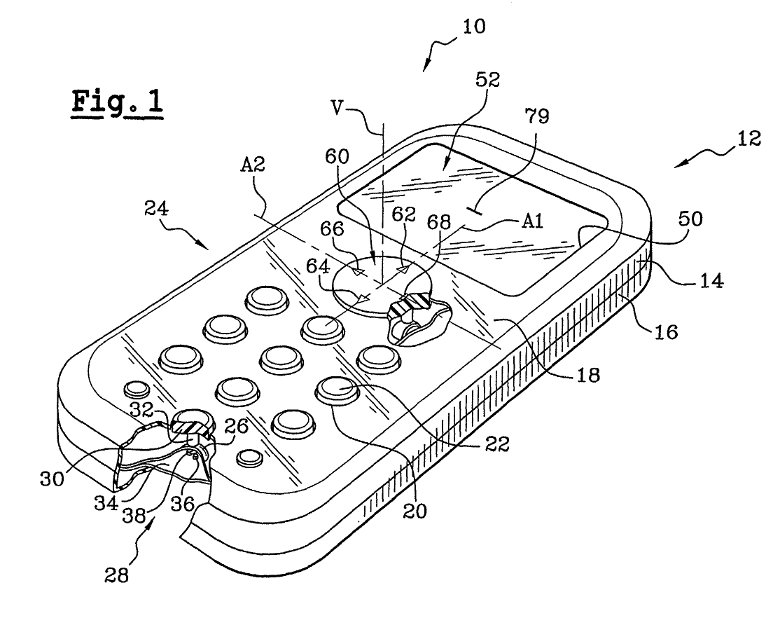

FIG. 1 is a perspective view of an electronic apparatus produced according to the state of the art,

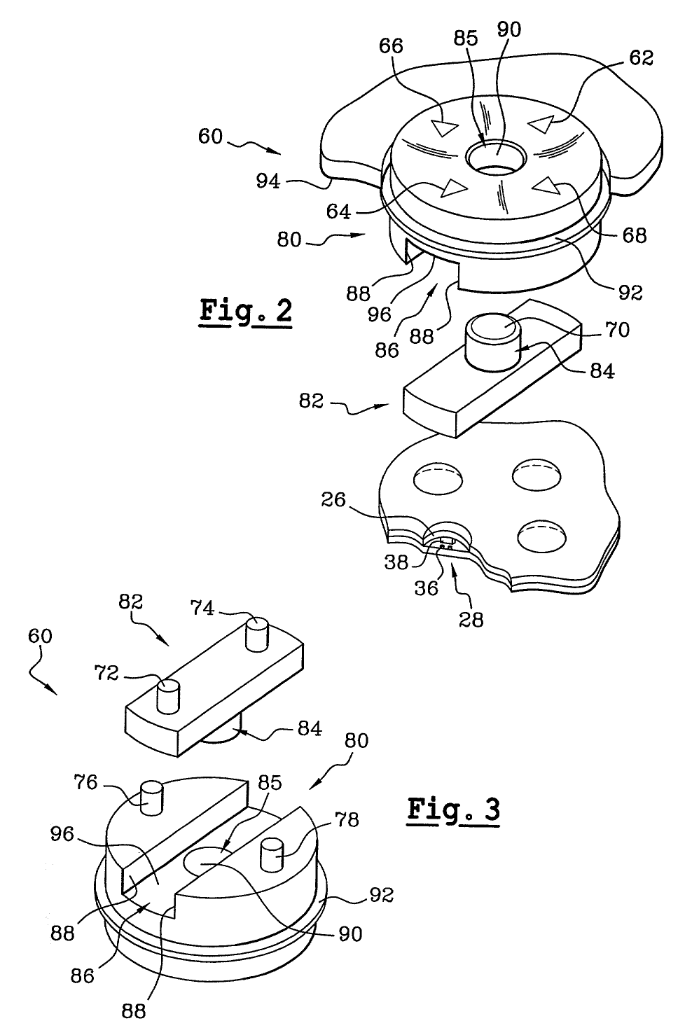

FIG. 2 is an exploded perspective view seen from above, in particular of the parts constituting a control member produced according to a first embodiment of the invention,

FIG. 3 is a perspective view seen from below of the control member produced according to the first embodiment of the invention,

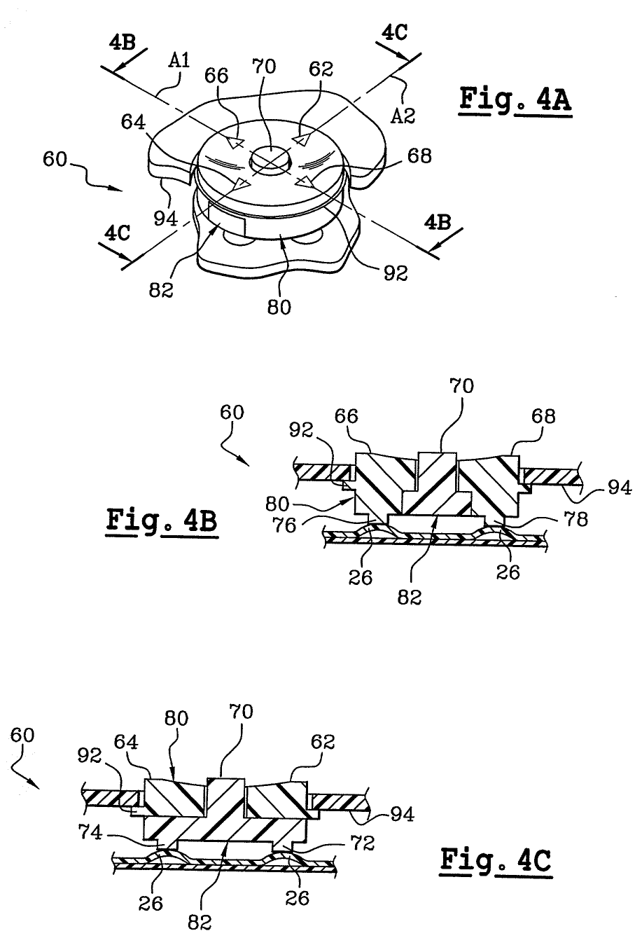

FIG. 4A is an assembled perspective view of the parts of the control member produced according to the first embodiment of the invention, in the idle position,

FIG. 4B is a view in cross-section of the control member along the line 4B-4B shown in FIG. 4A,

FIG. 4C is a view in cross-section of the control member along the line 4C-4C shown in FIG. 4A,

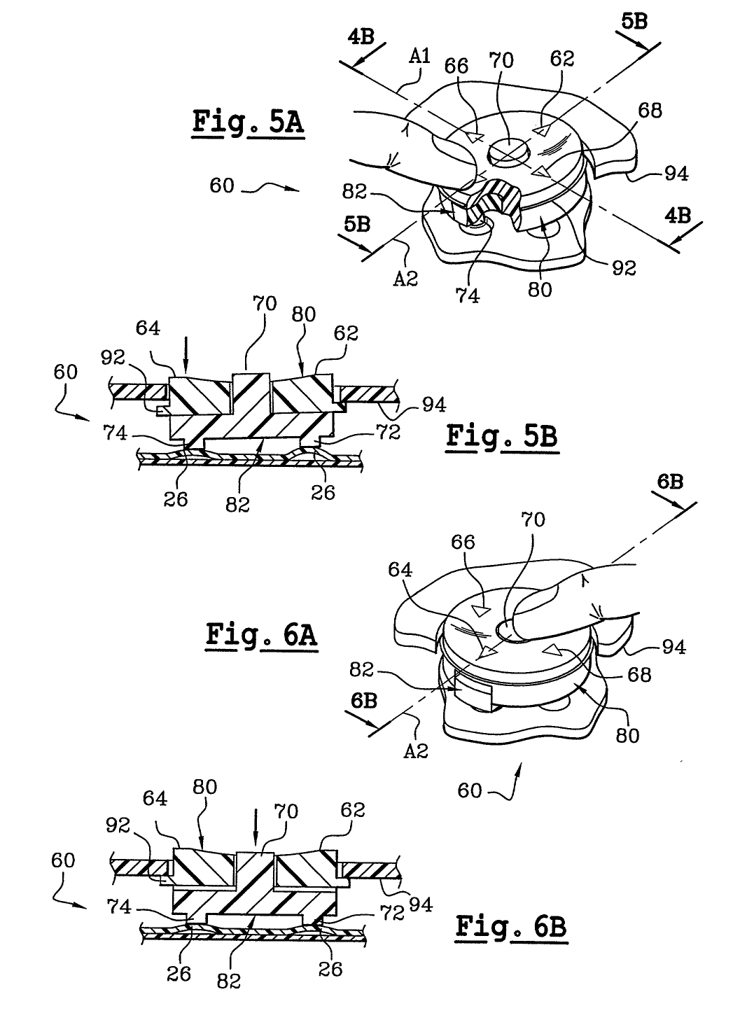

FIG. 5A is a perspective view in assembled perspective of the parts of the control member on a selection zone of one of which a control force is applied,

FIG. 5B is a view in cross-section of a control member along the line 5B-5B depicted in FIG. 5A,

FIG. 6A is a perspective view in assembled perspective of the parts of the control member on another selection zone of one of which a control force is applied,

FIG. 6B is a view in section of the control member along the line 6B-6B shown in FIG. 6A,

FIG. 7 is a view in transverse section of the control member according to a variant embodiment,

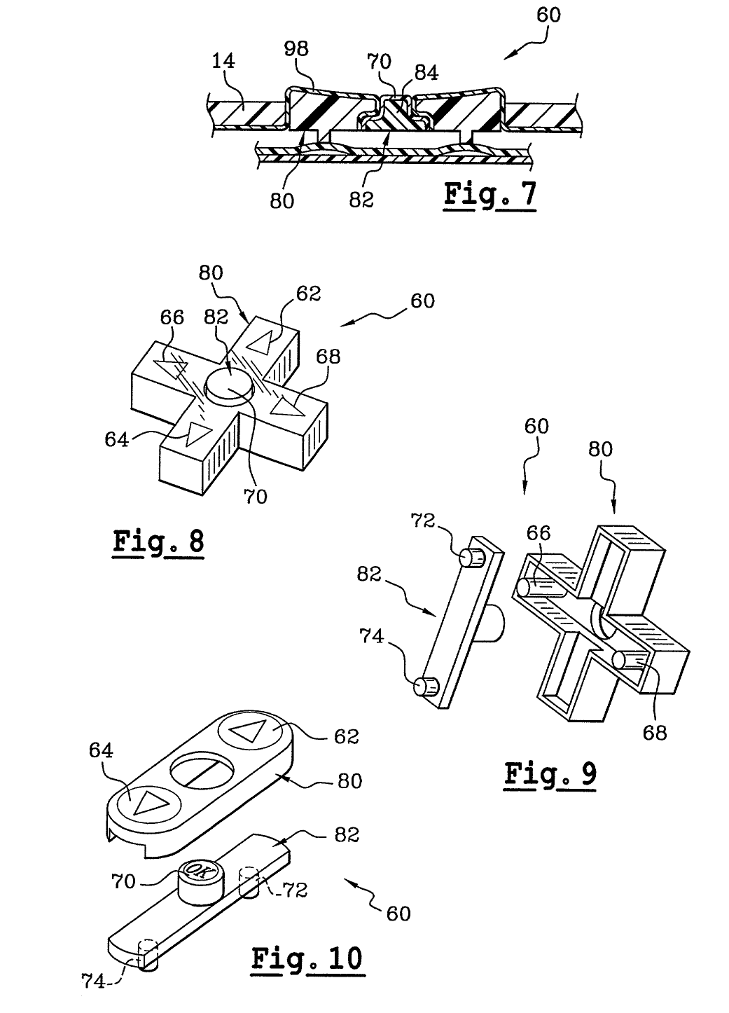

FIG. 8 is a perspective view of a control member produced according to a second embodiment of the invention,

FIG. 9 is an exploded perspective view of the control member produced according to the second embodiment of the invention

FIG. 10 is an exploded perspective view of a control member produced according to a third embodiment of the invention.

In the remainder of the description and the claims, a top and bottom orientation will be used, non-limitingly, in accordance with the orientation from top to bottom of the figures.

FIG. 1 shows an electronic apparatus 10 which is here, by way of example, a mobile telephone of the GSM type. The electronic apparatus 10 can also be an organizer, a game control device or a PDA (Personal Digital Assistant).

The telephone 10 has a casing 12 consisting of a top shell 14 and a bottom shell 16.

The top face 18 of the top shell 14 has orifices 20 which allow the passage of keys 22 of a keypad 24 of the telephone 10. The keys 22 are able to move vertically between an idle position and an actuation position in which each cooperates with a member 26 triggering an associated electrical switch 28.

The keypad 24 here consists of twelve keys 22 distributed in four horizontal series each of three keys.

The keys 22 consist principally of a top control part 30 on which a finger of the user can apply a control force. The part 30 forms the back of the corresponding key.

The keys 22 also consist of a rigid bottom actuation part 32 which is able to cooperate with the triggering member 26 of the associated electrical switch 28. The rigid bottom actuation part 32 is produced in the form of a central rod which extends vertically from the bottom face of the back of the top part 30 of the corresponding key 22, as far as the top wall of the triggering member 26 of the associated electrical switch 28, which is for example an elastically deformable dome.

Each electrical switch 28 consists principally of two metallic tracks 36 which belong to an associated electrical control circuit and which are not electrically connected together when the associated key 22 is in the idle position.

When the key 22 is in the actuation position, the bottom part 32 deforms the dome 26 so that an electrically conductive part 38 of its bottom face comes into contact with the two metallic tracks 36, thus modifying the electrical state of the associated electrical control circuit so as to control a function of the electronic apparatus 10.

The function can for example consist of taking the telephone line, dialing a digit of the number to join, moving a cursor in the display device 52 or validating a previously performed operation.

In general, the top parts 30 and the bottom parts 32 are produced in a single piece by the injection of a rigid material, such as plastic.

The metallic tracks (not shown) of the switches 28 are fixed, for example by metallization, to a common support element 34 which lies in a substantially horizontal plane and can be a plastic film. The tracks belong for example to the top face of a printed circuit board.

The top shell 14 of the casing 12 of the electronic apparatus 10 also has a window 50 through which a display device 52 passes, such as a liquid crystal display device, which is here substantially rectangular.

So as to facilitate the control of certain functions, in particular selection and validation functions, it is known that a control device can be used which consists of a control member 60 whose structure and functioning are similar to those of the keys 22.

The control member 60 has four opposite lateral top selection zones 62, 64, 66 and 68 to which it is possible to apply a control force and each of which is associated with a bottom actuation portion 72, 74, 76 and 78 which is able to cooperate with an associated triggering member of an electrical switch.

The control member 60 is here annular in shape overall. It is mounted so as to tilt about two selection axes A1, A2 which extend in a direction perpendicular to the direction of alignment of two opposite switches. The control member 60 is thus able to move between an idle position and two opposite selection positions for each selection axis A1, A2.

The application of a control force to each of the top selection zones 62, 64, 66 and 68 enables the corresponding bottom actuation portion 72, 74, 76 and 78 to cooperate with the associated triggering member and to activate a selection function.

Here, in accordance with FIG. 1, the selection function makes it possible to move the cursor 79 backwards, forwards, to the left or to the right on the screen 52, according to the top selection zone 62, 64, 66 and 68 on which the control force is applied so that the user can choose the function which he wishes to select.

The control member 60 is also mounted so as to be able to move in translation in a vertical validation direction V which is orthogonal to the alignment directions and to the selection axes A1 and A2, between the idle position and a pushed-in position. When a validation force is applied to the central validation zone 70 of the control member 60, the four bottom actuation portions 72, 74, 76 and 78 cooperate simultaneously with the associated triggering members so as to activate a validation function of the apparatus.

So as to resolve the problem described above, notably the lack of reliability in functioning of such a control device, the invention proposes, according to a first embodiment, that the control member 60 be produced in two parts 80 and 82, in accordance in particular with FIGS. 2 to 7.

In order to facilitate the understanding of the description and claims, the device according to the invention will, by way of non-limiting example, control selection and validation functions. According to variants the device can control dialing, picking up the line, etc.

A first top part 80 carries the lateral validation zones 62, 64, 66 and 68, which are distributed angularly at 90° around the central validation zone 70. In addition, the bottom face of the first part 80 carries the bottom actuation portions 76 and 78.

A second bottom part 82 carries the bottom actuation portions 72 and 74, and has a central stud 84 which passes vertically through an orifice 86 in the first part 80. The top free end face constitutes the third central validation zone 70.

In accordance with the figures, the bottom portion of the first part 80 has a recess 86 whose shape is complementary to that of the second part 82.

Thus, when a force is applied to a lateral validation zone 62 or 64, in accordance with FIGS. 5A and 5B, it causes the tilting along the axis A1 of the first top part 80, which drives the second bottom part 82 so that the bottom actuation portion 72 or 74 cooperates with the associated triggering member so as to cause the movement of the cursor towards the top or bottom of the display device 52 respectively.

When a force is applied to the central validation zone 70 of the control member 60, in accordance with FIGS. 6A and 6B, the two bottom portions 72 and 74 are moved in translation downwards so that they cooperate simultaneously with the two associated triggering members so as to activate the validation function of the apparatus.

So as to facilitate the simultaneous cooperation of the actuation portions 62, 64 with the associated triggering members, when the central zone 70 is actuated, the lateral walls 88 of the recess 86 in the first part 80 and the annular wall 90 of the orifice 80 form guidance means for the second part 82 during its vertical downward translational movement.

Thus the control device makes it possible to perform five different functions with only four electrical switches 28.

The reliability of such a system is optimal. This is because the central zone 70 is situated at equal distances from the bottom portions 72 and 74 so that, when a force is applied to the central zone 70, the free ends of the two bottom portions 72 and 74 remain in a horizontal plane during their downward movement.

This thus prevents any risk of offset between the times of cooperation of the two bottom portions 72 and 74 with the associated triggering members.

So as to allow the return of the two parts 80 and 82 to their idle positions, the control device 60 has elastic return means which are here the triggering members 26 of the switches 28. The triggering members 26 have the shape of resilient domes. Thus, when the domes are pressed in, they have a tendency each to return to their initial position in order to regain their shape.

The return of the parts 80 and 82 is limited upwardly by top stops.

In accordance with FIGS. 2 to 6, the top stop of the first part 80 is the bottom face 94 of the wall of the top casing 14 against which a rib 92, which extends over its external annular periphery, comes into contact in the idle position of the first part 80.

The second part 82 for its part is in abutment upwardly against a bottom surface 96 of the first part 80, which corresponds here to the top face of the recess 86.

According to a variant shown in FIG. 7, the first 80 and second 82 parts of the control member 60 are produced by the injection of plastics material into cavities formed in a connecting film 98.

In this case, the top stop of the first part 80 is the film 98 itself. Advantageously, the cavities intended to receive the other keys 22 of the keypad 24 are also formed in the film 98.

The first embodiment of the invention described above is not limiting.

According to a second embodiment depicted in FIGS. 8 and 9, the control member 60 has the shape of a star with four arms. Each arm of the star corresponds to the direction of movement of the cursor on the screen 52.

The free end of each of the arms carries the corresponding lateral selection zone 62 to 68 allowing the movement of the cursor in the direction of the arm.

The functioning of the control device according to this embodiment is similar to that of the first embodiment described above.

In a variant, the control device is multifunction. In this case, the actuation of a selection zone 62 to 70 can activate different functions according to the operating mode of the apparatus 10.

For example, the star-shaped control member 60 can constitute a part of the keypad.

Thus, when the telephone 10 is functioning in “dialing” mode, pressing on a selection zone 62 to 68 and on the central validation zone 70 makes it possible to dial a telephone number.

When the telephone is functioning in “navigation” mode, pressing on the lateral selection zones 62 to 68 moves the cursor on the screen and pressing on the central selection zone 70 validates the function selected.

According to a third embodiment of the control device depicted in FIG. 10, the first part 80 has only two lateral selection zones, for example 62 and 64. The second part 82 for its part carries the two bottom portions 72 and 74, as well as the central validation zone 70 which is situated in a similar fashion to the first embodiment on the top free end face of the central stud 84.

Such a control device thus makes it possible to move the cursor on the screen in two opposite directions, and to validate the function selected by actuating the central zone 70.

Thus, in order to perform three distinct functions, such a device requires only two electrical switches, not shown in these figures. In addition, the design in two parts 80, 82 of the control member 60 ensures the reliability of its functioning, by preventing any risk of offset between the times of cooperation of the two bottom portions 62, 64 with the associated triggering members.

The above description is given non-limitingly. This is because many variants can be envisaged.

For example, the first part can carry a higher number of lateral zones and associated bottom portions. This is in particular the case with a control device enabling the cursor to be controlled in eight directions distributed angularly at 45°.

The second part can also carry more than two bottom portions.

1. A device for controlling an electronic apparatus (10) of the type which consists of a control member (60) which has at least two opposite lateral top selection zones (62, 64, 66, 68) to which it is possible to apply a control force and each of which is associated with a bottom actuation portion (72, 74, 76, 78) which is able to cooperate with an associated triggering member (26) of an electrical switch (28), of the type in which the control member (60) is mounted so as to tilt about a selection axis (A1, A2) which extends in a direction perpendicular to the direction of alignment of the two switches (28), between an intermediate idle position and two opposite selection positions, when a force is applied to one or other of the top selection zones (62, 64, 66, 68), so that the corresponding bottom actuation portion (72, 74, 76, 78) cooperates with the associated triggering member (26) and activates a first or second selection function, and of the type in which the control member (60) is mounted so as to be able to move in translation in a vertical validation direction orthogonal to the direction of alignment and to the selection axis (A1, A2), between the idle position and a pressed-in position, when a validation force is applied to a third central validation zone (70) of the control member (60), in which the two opposite bottom actuation portions (72, 74, 76, 78) cooperate simultaneously with the two associated triggering members (26) so as to activate a validation function of the apparatus, characterized in that the control member (60) is produced in two parts (80, 82), a first top part (80) of which carries at least said two lateral validation zones (62, 64, 66, 68) and a second bottom part (82) of which carries at least said two bottom actuation portions (72, 74) and has a central stud (84) which passes vertically through the first part (80) and whose top free end face constitutes the third central validation zone (70).

2. A control device as claimed in the preceding claim, characterized in that the first part (80) has four lateral selection zones (62, 64, 66, 68) which are distributed angularly at 90° around the central validation zone (70) and each of which is associated with a bottom portion (72, 74, 76, 78), and in that the four bottom portions (72, 74, 76, 78) are carried by the second part (82), so that, when a validation force is applied to the central validation zone (70), the four bottom portions (72, 74, 76, 78) cooperate simultaneously with the associated triggering members (26) in order to activate the validation function.

3. A control device as claimed in claim 1, characterized in that the first part (80) has four lateral selection zones (62, 64, 66, 68) which are distributed angularly at 90° around the central validation zone (70) and each of which is associated with a bottom portion (72, 74, 76, 78), and in that the two opposite bottom portions (72, 74) are carried by the second part (82), the other two opposite bottom portions (76, 78) being carried by the bottom face of the first part, so that, when a validation force is applied to the central validation zone (70), the two bottom portions (72, 74) carried by the second part cooperate simultaneously with the associated triggering members (26) in order to activate the validation function.

4. A control device as claimed in any one of the preceding claims, characterized in that it has means for the elastic return of the two parts (80, 82) against top stops which define their idle positions.

5. A control device as claimed in the preceding claim, characterized in that the top stop of the second part (82) is a bottom surface (96) of the first part (80).

6. A control device as claimed in one of claims 4 or 5, characterized in that the elastic return means belong to the associated electrical switches (28).

7. A control device as claimed in any one of the preceding claims, characterized in that it has means of guiding the second part in vertical translation so as to assist the simultaneous cooperation of the actuation portions (72, 74, 76, 78) which it carries with the associated triggering members (26), when the central zone (70) is controlled.

8. An electronic apparatus which comprises a control member (60) as claimed in any one of the preceding claims, characterized in that it consists of a mobile telephone of the GSM type.
